(19) United States
(12) Patent Application Publication
(10) Pub. No.: US 2007/0123226 A1
(43) Pub. Date: May 31, 2007

(54) Data service system and access control method

(76) Inventors: Wenyong Liang, Shenzhen (CN); Yang Zhao, Shenzhen (CN)

Correspondence Address: MCANDREWS HELD & MALLOY, LTD, 500 WEST MADISON STREET, SUITE 3400, CHICAGO, IL, 60661, US

(21) Appl. No.: 11/495,998

(22) Filed: Jul. 28, 2006

(30) Foreign Application Priority Data
Jul. 29, 2005 (CN) 200510088749.7

(51) Int. Cl. H04Q 7/38; H04Q 7/22; H04M 3/42

(52) U.S. Cl. 455/414.1

(57) ABSTRACT

A data service system and a method for access control. The data service system includes a plurality of service servers, through which terminals subscribe relevant services. The system further includes a public access control unit, which is connected to the plurality of service servers, in which the public access control information is set; the service server is used to obtain an authorization result of the service request and perform access control for the service according to the authorization result; the authorization result comprises the result of authorization for the service request from the terminal according to the public access control information. By using the data service system and access control method of the present invention, when a user subscribes a new service, it may be directly configured to use public access control list strategy to make all-in-one setup for certain public policies, and thus enrich the user's experience.

### RELATED APPLICATIONS

This patent application makes reference to, claims priority to and claims benefit from Chinese Patent Application No. 200510088749.7 filed on Jul. 29, 2005.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

The present invention relates to telecommunication field, and particularly relates to a data service system and an access control method.

Currently, with new services in mobile telecommunications field emerging frequently, whether the service provider can provide better experiences for its users becomes the key to a successful service. The major services based on IP multimedia subsystem (IMS) include push-to-talk over cellular (PoC), instant messaging (IM), Presence service and so on. In the near future, the services based on IMS will become even more versatile.

Push-to-talk over cellular (PoC) service is a two-way form of communication that allows users to instantly communicate with one or more users. The PoC service is similar to a “walkie-talkie” service, in which, by pressing a button, the user can communicate with another user or is broadcasted to participants of a group. After the initial voice is finished, other participants may respond to that voice message. The PoC communication is half-duplex, which means that at a time there is at most one participant talk while all the other participants may only hear.

The “Presence service” is a kind of telecommunication service which collects and issues the presence information, and generally is provided together with the IM service.

One of the common features of the three services mentioned above (may include more services emerged later which are based on IMS) is that an access control list is needed. The basic function of access control list is to allow some users access services but block others. However, each specific service has its own special function setups. For example, the Presence service provides a function of polite block. FIG. 1 shows the structure schematic diagram of data service. As shown in FIG. 1, in the present standard data service architecture, each service maintains its own access control list and needs to authorize each service individually. It can be imagined that, when a user subscribes many services and each service needs to maintain its own access control information, the user has to make more repetitive efforts.

In the present data service architecture, each service engine maintains a XML document management server (Access Control Unit), in which the access control list is stored in the form of XML documents. The service server interacts with the XML document management server in the XCAP protocol of Internet Engineering Task Force (IETF). For detailed information, please refer to “The Extensible Markup Language (XML) Configuration Access protocol (XCAP)”, J. Rosenberg.

FIG. 2 illustrates a flow chart of how a data service Presence service uses an access control list. After the Presence server receives a subscription request, it obtains an access control list from the Presence XML Document Management Server through XCAP protocol. It analyzes whether rules are matching or not, and combines them if multiple rules exist. Finally, it judges a process for the subscription according to the key value of the access control list, and the process method can includes, for example, Allow, Not To Determine, Polite Block, and Block.

For access control lists of other service engines, the data service architecture also uses similar process method and flow. Of course, there may be a difference between these process methods. For example, Polite Block is not available in PoC.

In the present data service architecture, since each service maintains an access control list, it is imaginable that when a user subscribes many services, the architecture has to set up an overall access control strategy for each service. When a user needs to block all his subscriptions from a certain person, the user also needs to block services one by one.

### BRIEF SUMMARY OF THE INVENTION

The present invention provides an data service system and a method for access control of the services.

The present invention provides a data service system, which includes a plurality of service servers, through which the terminals subscribe relevant services. The data service system further includes a public access control unit, which is connected to a plurality of the service servers, and in which the public access control information is set. The service servers are used for obtaining authorization result of the service request which is sent from the terminal to the service servers and performs access controls of the service access according to the authorization result. The authorization result is obtained after authorizing service request from the terminal according to the public access control information.

The above system further includes a dedicated access control unit which is connected to the corresponding service server and is provided with dedicated access control information. The authorization result further includes the result of authorization for the service request from the terminal according to the dedicated access control information.

When the authorization result is the result of authorization for the service request from the terminal according to the public access control information and the dedicated access control information, if the authorization result according to the public access control information is in conflict with the authorization result according to the dedicated access control information, the final authorization result is the result of authorization according to the dedicated access control information.

The public access control unit is provided with a public access control list, which is used to set the public control information.

The public access control unit is provided with Uniform Resource Identifier for the dedicated access control list, which is used to identify where the dedicated access control information locates.

The dedicated access control unit is provided with dedicated access control list, which is used to set the dedicated access control information.

The dedicated access control unit is provided with Uniform Resource Identifier for public access control list, which is used to identify where the public access control information locates.

The service servers and the public service access control unit communicate through XCAP protocol; the service server and the dedicated service access control unit communicate through XCAP protocol.

The access control can include, but are not limited to, Allow, Not To Determine, Polite Block or Block.

The present invention also provides an access control method, which can be used for data service system being provided with a public access control unit that includes public access control information. The method includes the steps of:
originating a service request to a service server from a terminal;
obtaining authorization result of the service request by the service server, and
performing access control of the service according to the authorization result.

The authorization result is obtained after authorizing for the service request from the terminal according to public access control information.

The authorization result further can include the result of authorization for the service request from the terminal according to the dedicated access control information.

The authorization result is the result of authorization for the service request from the terminal according to the public access control information and the dedicated access control information. If the authorization result according to the public access information is in conflict with the authorization result according to the dedicated access control information, the final authorization result is the result of authorization according to the dedicated access control information.

The result of authorization for the service request from the terminal according to the public access control information is obtained by the public access control unit after it authorizes the service request according to the public access control information.

The result of authorization for service request from the terminal according to the public access control information is obtained after the service server obtains the public access control information and authorizes the service request according to the public access control information.

The access control information is set in the access control list, or is linked to the access control list through a URI.

The access control can include, for example, Allow, Not To Determine, Polite Block or Block.

By using the data service system and access control method of the present invention, when a user subscribes a new service, it may be directly configured to use public access control list strategy to make all-in-one setup for certain public policies, and thus enrich the user's experience.

### BRIEF DESCRIPTION OF SEVERAL VIEWS OF THE DRAWINGS

FIG. 1 is a structure schematic drawing of a data service system.

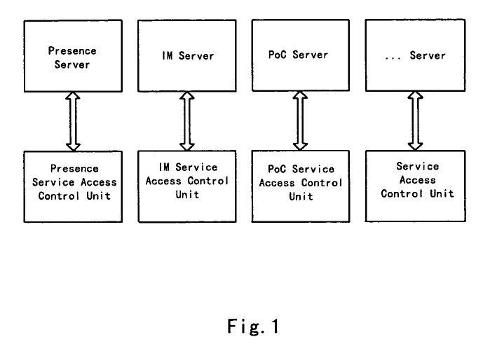

FIG. 2 is a flow chart for access control.

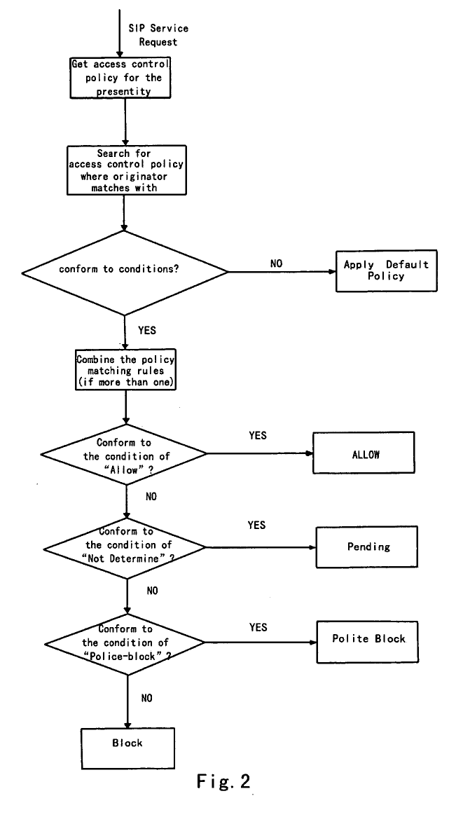

FIG. 3 is a structure schematic drawing of a data service system according to an embodiment of the present invention.

FIG. 4 is a flow chart for access control according to an embodiment of the present invention

### DETAILED DESCRIPTION OF THE INVENTION

The present invention is hereinafter explained in detail with reference to the accompanying figures and embodiments.

An embodiment of the present invention adopts a central access control list management strategy, and provides a central storage entity for public access control list. In this way, the public access control list in the central storage entity will be applied to all services subscribed by all users. When a user subscribes a new service, the user may directly set to use the public access control list strategy.

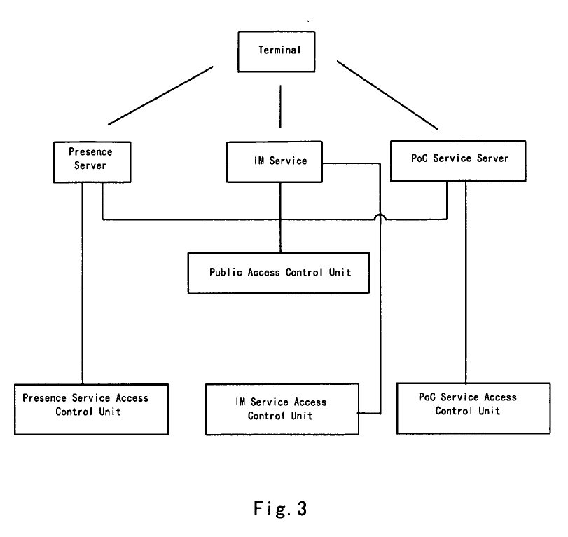

FIG. 3 is a structure schematic drawing of the data service system according to an embodiment of the present invention. As shown in FIG. 3, the system includes: a plurality of service servers, by which the terminal subscribes relevant services; and dedicated service access control units corresponding to each service server.

The dedicated access control unit, which provides dedicated access control information and, is connected to its corresponding service server, verifies the subscription service request originated by the terminal according to the dedicated access control information, and returns the result of verification to the service server.

The embodiment of the present invention has public access control unit. The public access control unit, which provides dedicated access control information and is connected to a plurality of service servers, verifies the subscription service request originated by the terminal according to the public access control information in response to the inquiring request sent by the service server, and returns the result of verification to the service server.

Once the public access control unit is added, if the access control information searched from the public access control unit is enough for a data service, there is no need to set the dedicated access control unit.

In the above data service system, the service server and the public service access control unit communicate with each other through XCAP protocol; and the service server and the dedicated service access control unit communicate with each other through XCAP protocol.

The embodiment of the present invention may provide access control list in the public access control unit and the dedicated access control unit or only in the public access control unit, wherein the public access control list is provided with the public access control information of the terminal.

The embodiment of the present invention may provide Uniform Resource Identifier (URI) of the access control list, which identifies where the access control information is, in the public access control unit and the dedicated access control unit. The URI of the access control list may also be set in the following schemes:

The URI of the dedicated access control list is set in the public access control unit to identify where the dedicated access control information is.

The URI of the public access control list is set in the dedicated access control unit to identify where the public access control information is.

It is possible to position the relevant access control list through the URI, and when necessary, the access control list corresponding to the URI may be retrieved and used directly.

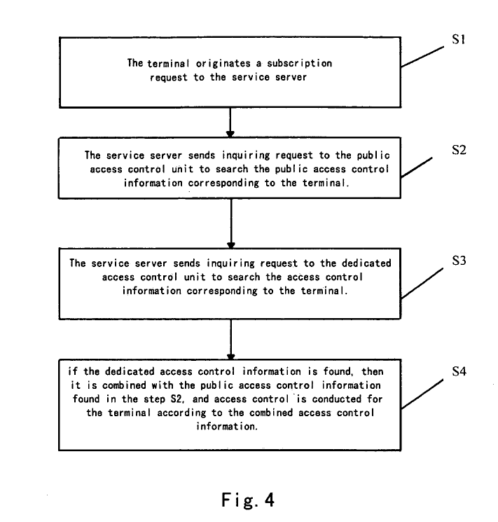

FIG. 4 is a flow chart of access control according to an embodiment of the present invention. As shown in FIG. 4, the embodiment of the present invention mainly includes the following steps:

S1, the terminal originates a service request to the service server;

As a beginning of a service access, the terminal sends a subscription request of certain service, which is provided by the service server, to the service server. The service may be PoC, IM, or Presence, and so on.

S2, the service server sends inquiring request to the public access control unit to search the public access control information corresponding to the terminal.

The embodiment of the present invention sets up public access control information. For the subscription request from the terminal, the service server needs to send inquiring request to the public access control unit and search the public access control information corresponding to the terminal. And the public access control information is generally common access control information.

If there is dedicated access control information in the dedicated access control unit, continue to execute S3: otherwise, conduct the access control according to the public access control information searched from the public access control unit.

S3, the service server sends inquiring request to the dedicated access control unit to search the access control information corresponding to the terminal.

The public access control information is generally common access control information. However, each service server may have its own specific access control strategy according to its own special characteristics. Therefore, the pubic access control information may only describe a few of the most basic access control key values, such as Allow or Block. For some dedicated access control information, it is also necessary to set a dedicated access control unit.

S4, if the dedicated access control information is found, it is combined with the public access control information found in the step S2, and access control is conducted for the terminal according to the combined access control information.

Based on step S2, the service server sends inquiring request to the dedicated access control unit, and searches for access control information corresponding to the terminal. If the relevant access control information is found, it is combined with the public access control information found in step S2, and access control is conducted for the terminal according to the combined information.

If the result of the access control according to the public access control information is in conflict with the result according to the dedicated access control information, for example one is Allow and the other is Block, the service server performs the processes according to the dedicated access control information. Other than result information of authorization such as Allow or Block, the public access control information may also return a complete public access control list to the service server, which can buffer the list. In this way, it is not necessary to request the information at every time of authorization, and thus network flux is saved. At the same time, the service server may subscribe the notice of the change of the public access control list. That is, when the content of the access control list changes, such as addition of URIs in the list or deletion of URIs from the list, the changed information is informed to the service server, and it is only conducted for the service server to update its locally buffered list.

Public access control unit may directly conduct authorization according to the inquiring request including requester terminal's URI sent by the service server, and return the authorization results such as Allow or Block. Public access control unit also may return the public access control list corresponding to the requester terminal's URI to the service server, and the service server conducts the authorization.

In the embodiment of the present invention, when the service server needs to search the access control information of the terminal in the dedicated access control unit, the sequence of step S2 and step S3 may be exchanged, i.e., after inquiring in step S3, inquiring in step S2 is another alternative to the embodiment of the present invention, the inquiring results are combined in step S4, and access control for the terminal is conducted according to the combined information.

In the embodiment of the present invention, the public access control information and the dedicated access control information may be recorded as lists respectively, which are descried in the form of XML files. There are three schemes as follows:

Scheme 1: Directly Setup a Public Access Control List

TABLE 1
The Public Access Control List

```
<?xml version=“1.0” encoding=“UTF-8”?>
<cr:ruleset
  xmlns:cr=“urn:ietf:params:xml:ns:common-policy”
  <cr:rule id=“ck81”>
    <cr:conditions>
      <cr:identity>
        <cr:id>tel:+43012345678</cr:id>
        <cr:id>sip:hermione.blossom@example.com</cr:id>
      </cr:identity>
    </cr:conditions>
    <cr:actions>
      <sub-handling>allow</sub-handling>
    </cr:actions>
    <cr:transformations>
      <provide-tuples>
        <all-tuples></all-tuples>
      </provide-tuples>
    </cr:transformations>
  </cr:rule>
  <cr:rule id=“fe23”>
    <cr:conditions>
      <cr:identity>
        <cr:id>tel:+13510112474</cr:id>
        <cr:id>sip:abc@huawei.com</cr:id>
      </cr:identity>
    </cr:conditions>
    <cr:actions>
      <sub-handling>block</sub-handling>
    </cr:actions>
    <cr:transformations>
      <provide-tuples>
        <all-tuples></all-tuples>
      </provide-tuples>
    </cr:transformations>
  </cr:rule>
</cr:ruleset>
```

In the public access control list as shown in Table 1, the item of <identity> describes URI-+43012345678 and sip: hermione.blossom@example.com on which the influence need to be imposed, and the item of <action> describes the access control information that needs to be applied, such as Allow or Block. Table 1 allows +4301234568 and sip:hermione.blossom@example.com, and blocks the access of +13510112474 and abc@instance.com.

In the scheme as shown in table 1, each service server reads public access control list directly, and conducts relevant authorization. Alternatively, if the service server also needs to conduct additional controls besides the key values set in the public access control list, it may read the dedicated access control list special to the service server and combine the dedicated access control list with the public access control list for use.

Scheme 2: Setup URI Table Relevant to the Key Values

In this scheme, a relevant URI table is setup according to the key values without directly storing public access control lists. For example:

Shared access control list server stores Allow URI tables such as Table 2 below, which is a relevant URI table of access control of the user Wanghao.

TABLE 2

```
<?xml version=“1.0” encoding=“UTF-8”?>
  <list name=“Allow”>
    <entry uri=“sip:hermione.blossom@example.com”>
      <display-name>Hermione</display-name>
    </entry>
    <entry uri=“tel:5678;phone-context=+43012349999”/>
</list>
```

Scheme 3: Dedicated Access Control Unit Stores an Access Control List

The dedicated access control unit stores an access control list in itself. In the items of Allow and Block, External list of the existing data service mechanism is used to refer to relevant key values, to achieve access control of the services.

The implementation of External List mechanism is shown in the following example as represented by Table 3, by adding <external> and its attribute <anchor>, position the external list and its attributes, and refer them to the present table.

TABLE 3

```
<?xml version=“1.0” encoding=“UTF-8”?>
<resource-lists xmlns=“urn:ietf:params:xml:ns:resource-lists”
    xmlns:xsi=“http://www.w3.org/2001/XMLSchema-instance”>
  <list name=“allow”>
    <external anchor=“http://xcap.example.com/services/resource-
      lists/users/sip:wanghao@example.com/wanghao.xml/˜˜
      /list%5b@name=%22Allow%22%5d”>
      <display-name>allow</display-name>
    </external>
  </list>
</resource-lists>
```

Employing the technical solution of the present invention, when a user subscribes a new service, the user may directly set to use the public control access control list strategy.

Obviously, a person skilled in the art may make various variations and modifications without going beyond the spirit and scope of the present invention. Therefore, if the modification and variation for the present invention are covered by the claims of the prevent invention or their equivalent techniques, the present invention intends to cover such modifications and variations.

1. A data service system, comprising a plurality of service servers, through which terminals subscribe relevant services, and further comprising:
a public access control unit, which is connected to the plurality of service servers, and in which public access control information is set,
wherein the service servers are used for obtaining an authorization result of a service request sent from a terminal to the service servers, and performing access controls of the service requested according to the authorization result,
wherein the authorization result comprises a first result of authorization for the service request from the terminal according to the public access control information.

2. The data service system as claimed in claim 1, further comprising a dedicated access control unit which is connected to the corresponding service server and is provided with dedicated access control information, wherein the authorization result further comprises a second result of authorization for the service request from the terminal according to the dedicated access control information.

3. The data service system as claimed in claim 2, wherein, when the authorization result comprises the first result of authorization for the service request from the terminal according to the public access control information and the second result of authorization according to the dedicated access control information, if the first result of authorization according to the public access control information is in conflict with the second result of authorization according to the dedicated access control information, the second result of authorization according to the dedicated access control information is regarded as the authorization result.

4. The data service system as claimed in claim 1, wherein the public access control unit is provided with a public access control list which is used to set the public control information.

5. The data service system as claimed in claim 2, wherein the public access control unit is provided with a public access control list which is used to set the public control information.

6. The data service system as claimed in claim 2, wherein the dedicated access control unit is provided with a dedicated access control list, which is used to set the dedicated access control information.

7. The data service system as claimed in claim 6, wherein the public access control unit is provided with Uniform Resource Identifier for the dedicated access control list, which is used to identify where the dedicated access control information is.

8. The data service system as claimed in claim 5, wherein the dedicated access control unit is provided with a dedicated access control list, which is used to set the dedicated access control information.

9. The data service system as claimed in claim 8, wherein the dedicated access control unit is provided with Uniform Resource Identifier for the public access control list, which is used to identify where the public access control information locates.

10. The data service system as claimed in claim 1, wherein the service servers and the public service access control unit communicate through XCAP protocol, wherein the service server and the dedicated service access control unit communicate through XCAP protocol.

11. The data service system as claimed in claim 2, wherein the service servers and the public service access control unit communicate through XCAP protocol, wherein the service server and the dedicated service access control unit communicate through XCAP protocol.

12. The data service system as claimed in claim 1, wherein the access control comprises Allow, Not To Determine, Polite Block or Block.

13. The data service system as claimed in claim 2, wherein the access control comprises Allow, Not To Determine, Polite Block or Block.

14. An access control method for a data service system having a public access control unit that includes public access control information, comprising the steps of:
originating a service request to a service server from a terminal;
obtaining an authorization result of the service request by the service server; and
performing access control of the service according to the authorization result,
wherein the authorization result comprises a first result of authorization for the service request from the terminal according to the public access control information.

15. The access control method as claimed in claim 14, wherein the authorization result further comprises a second result of authorization for the service request from the terminal according to dedicated access control information.

16. The access control method as claimed in claim 15, wherein, when the authorization result comprises the first result of authorization for the service request from the terminal according to the public access control information and the second result of authorization according to the dedicated access control information, if the first result of authorization according to the public access information is in conflict with the second result of authorization according to the dedicated access control information, the second result of authorization according to the dedicated access control information is regarded as the authorization result.

17. The access control method as claimed in claim 14, wherein the first result of authorization for the service request from the terminal according to the public access control information is obtained after the public access control unit authorizes the service request according to the public access control information.

18. The access control method as claimed in claim 15, wherein the first result of authorization for the service request from the terminal according to the public access control information is obtained after the public access control unit authorizes the service request according to the public access control information.

19. The access control method as claimed in claim 14, wherein the first result of authorization for the service request from the terminal according to the public access control information is obtained after the service server obtains the public access control information and authorizes the service request according to the public access control information.

20. The access control method as claimed in claim 15, wherein the first result of authorization for the service request from the terminal according to the public access control information is obtained after the service server obtains the public access control information and authorizes the service request according to the public access control information.

21. The access control method as claimed in claim 14, wherein the access control information is set in an access control list, or is linked to the access control list through a URI.

22. The access control method as claimed in claim 15, wherein the access control information is set in an access control list, or is linked to the access control list through a URI.

23. The access control method as claimed in claim 14, wherein the access control comprises Allow, Not To Determine, Polite Block or Block.

24. The access control method as claimed in claim 15, wherein the access control comprises Allow, Not To Determine, Polite Block or Block.
